(19) United States
(12) Patent Application Publication
(10) Pub. No.: US 2025/0128314 A1
(43) Pub. Date: Apr. 24, 2025

(54) PROTECTIVE DEVICE, BENDING MACHINE AND METHOD FOR OPERATING A BENDING MACHINE

(71) Applicant: Fiessler Elektronik GmbH & Co. KG, Aichwald (DE)

(72) Inventors: Lutz Fiessler, Aichwald (DE); Frank Müller, Plochingen (DE)

(21) Appl. No.: 18/920,104

(22) Filed: Oct. 18, 2024

(30) Foreign Application Priority Data
Oct. 19, 2023 (EP) 23204606.0

(51) Int. Cl. B21D 55/00; F16P 3/14

(52) U.S. Cl. CPC B21D 55/00; F16P 3/144

(57) ABSTRACT

Protective device for safeguarding an operating gap of a bending machine, having an optical source to provide an optical beam along the operating gap, having an optical receiver arranged opposite the optical source to receive the optical beam, a safety-oriented light barrier controller that performs redundant processing of sensor signals provided from the optical receiver, and a linear drive system for attachment to the bending machine and for providing linear movements for the optical source and the optical receiver relative to an upper tool of the bending machine. The linear drive including a linear drive and a safety-oriented position measuring system with a position sensor and a position checking system, in which a safety-oriented linear drive controller is connected to the linear drive system and processes sensor signals from the position sensor and signals from the position checking system and provides a closed loop control for the linear drive.

### CROSS-REFERENCE

This application claims the benefit of European application EP 23204606.0, filed Oct. 19, 2023, which is incorporated herein by reference.

The invention relates to a protective device, a bending machine and a method for operating a bending machine.

DE 1 971 7299 A1 discloses a protective device for machines such as press brakes, cutting machines, punching machines, in which a first machine part performs working movements against a second machine part, wherein a first light barrier, in particular a laser light barrier, whose light beam extends perpendicular to the direction of the working movement, can be positioned between the two machine parts on one of them in such a way that its light beam comprises a safety distance from this machine part, and wherein a blocking device is provided which halts the working movement when this light beam is interrupted, and wherein a switch-off device switches off the blocking device immediately before this light beam is interrupted by the other machine part. A second light barrier, used to set the safety distance, is mounted together with the first light barrier on a safety device arranged on one machine part in an adjustable manner in the direction of the working movement, whereby the light beam of the second light barrier runs parallel to the light beam of the first light barrier between the latter and the one machine part, and whereby the distance between the two light beams essentially corresponds to the safety distance.

DE 10123562 describes a protective device for machines such as press brakes, cutting machines, punching machines or the like, in which a first machine part performs working movements against a second machine part, wherein at least one light barrier can be positioned between the two machine parts on one of them so that its light beam comprises a safety distance to this machine part, which distance can be adjusted by a safety device carrying the light barrier, and when the light beam is interrupted, a blocking device stops the working movement. Furthermore, means are provided for carrying out a first movement of the safety device until the light beam is interrupted by the machine part carrying the safety device, and for carrying out a second movement of the safety device in the opposite direction, the distance of the second movement, which determines the safety distance, being predeterminable by an electrical measuring and/or control device.

### SUMMARY

The object of the invention is to provide a protective device for a bending machine, a bending machine and a method for operating a bending machine, with which an improved level of safety can be achieved.

This object is solved with a protective device for securing an operating gap of a bending machine. For this purpose, the protective device comprises an optical source for the provision of an optical beam in the operating gap, and an optical receiver arranged opposite the optical source to receive the optical beam from the optical source, and a safety-oriented light barrier controller that performs redundant processing of sensor signals of the optical receiver, and a linear drive system to provide linear movements for the optical source and the optical receiver relative to a machine frame of the bending machine or relative to an upper tool of the bending machine, the linear drive system comprising a linear drive and a safety-oriented position-measuring system with a position sensor and a position checking system, wherein a safety-oriented linear drive controller is connected with the linear drive system and processes sensor signals from the position sensor and signals from the position checking system and provides a closed loop control for the linear drive.

The task of the protective device is to safeguard a variable-size operating gap of a bending device, which may be, for example, a press brake or a bending machine. This safeguard is designed to protect an operator of the bending device from the risk of crushing, particularly of the operator's fingers, when manually inserting a workpiece into the operating gap for a forming operation or manually aligning the workpiece immediately before the forming operation is carried out.

On a press brake, for example, an upper tool is moved towards a lower tool, which lower tool forms the workpiece support surface for the workpiece, in order to perform the bending operation. Due to this movement of the upper tool the operating gap between upper tool and lower tool is narrowed and thus there is a risk that the operator's fingers, hand or forearm may be crushed in the operating gap between the upper tool and the lower tool or between the upper tool and the workpiece inserted into the operating gap.

In a folding machine, the operating gap is defined by a workpiece holder and a workpiece support surface or a workpiece resting on the workpiece support surface, whereby the holder is moved towards the workpiece support surface, thereby reducing the size of the operating gap, in order to secure the workpiece for the subsequent folding process. Here too, there is a risk of the operator's fingers, hand or forearm being crushed in the operating gap when the workpiece holder approaches the workpiece support surface and the size of the operating gap is reduced.

Accordingly, the purpose of the protective device is to secure the operating gap in such a way that an approach process for the upper tool to the lower tool or to the workpiece support surface is interrupted if an operator reaches into the operating gap and the operating gap has already been reduced in such a way that there is a risk to the operator.

The optical source provided for this purpose emits an optical beam, preferably a bundle of at least almost parallel rays, in particular in a wavelength range between 360 nm and 850 nm. The optical beam may be a monochromatic beam. The optical beam can be provided, for example, as a single beam, in particular as a laser beam or as an arrangement of a plurality of beams aligned, at least almost, parallel to one another or aligned with one another in the manner of a light curtain, or as a band-shaped beam arrangement. It is preferably provided that an optical axis of the optical source is aligned parallel to a lower edge of the upper tool. The lower edge of the upper tool is that part of the upper tool which is located nearest to the lower tool or the workpiece support surface. It is particularly preferably provided that the optical beam extends along the entire lower edge of the upper tool and thus covers an overall width of the operating gap.

The optical receiver is an electric or electronic component, in particular from the group: light-sensitive diode, light-sensitive diode array, CCD camera chip, and is designed to receive at least some optical rays of the optical beam and to provide an electric sensor signal, which electric sensor signal is related to the light intensity of the optical rays impinging on the optical receiver. The optical receiver is preferably arranged opposite the optical source in such a way that all the rays of the optical beam impinge on the optical receiver, if no interfering contour is located in the optical path between the optical source and the optical receiver. The optical receiver provides the electrical sensor signal to a safety-oriented light barrier controller, whereby the electrical sensor signal can be an analog signal or a digitally coded signal. The electrical sensor signal particularly represents a light intensity of the rays of the optical beam received by the optical receiver. In the light barrier controller, an evaluation of the electrical sensor signal is carried out, particularly using a threshold value stored in the light barrier controller, in order to be able to determine whether the optical beam provided by the optical source reaches the optical receiver without interference or whether an interfering contour, for example a finger or hand of an operator, is located in the optical path between the optical source and the optical receiver.

The safety-oriented light barrier controller is designed in particular for redundant processing of the electrical sensor signal of the optical receiver. The redundancy for processing the sensor signals can, for example, be realized by using two independently operating processors in the light barrier controller, which both process the sensor signal of the optical receiver. The two independently operating processors may be of the same kind or type or may be of different types. The software as used for the two independently operating processors may be identical for both processors or different for each of the processors. Preferably the light barrier controller is designed to provide an interruption signal if, during the redundant processing of the sensor signal, a difference greater than a predetermined maximum difference occurs between the two processing results for the sensor signal. On the occurrence of such interruption signal the linear drive is stopped. As an alternative to providing an interruption signal, the light barrier controller can also be designed to provide an enable signal, which is only output, however, if there is no interruption of the optical beam and/or no exceeding of the predetermined maximum difference between the two processing results for the sensor signal. In this case the linear drive only may be activated if the enable signal is provided by the light barrier controller.

In order to ensure that the protective device provides an adequate level of protection, it is intended that the optical source and the optical receiver be attached to a linear drive system, which in turn is intended for attachment to a machine frame of the bending machine or to the upper tool or a guide for the upper tool. The linear drive system can be used to provide a linear relative movement of the optical source and the optical receiver along an axis of movement, whereby this axis of movement is determined by the direction of the relative movement between the upper tool and the lower tool or the upper tool and the workpiece support surface. Typically, the axis of movement is aligned in a vertical direction.

The linear drive system includes a linear drive that can be activated by the light barrier controller to effect the desired linear relative movement of the optical source and the optical receiver along the axis of movement. By way of example, the linear drive includes an electric motor, for example a stepper motor, which is assigned a gear mechanism for converting a rotational movement of the electric motor into the desired linear movement. Alternatively, the linear drive can be designed, for example, as an electrodynamic linear direct drive or as a fluid-driven linear cylinder. A linear movement provided by the linear drive can be introduced to a carrier part that is arranged on the machine frame or on the upper tool in a linearly movable manner and to which the optical source and the optical 15 receiver are jointly attached. Alternatively, the optical source and the optical receiver can each be separately attached to the machine frame or the upper tool so that they can move linearly and be coupled to the linear drive by a pulling mechanism, for example a toothed belt or a cable, in order to ensure that the optical source and the optical receiver move synchronously. In another alternative linear drive design, both the optical source and the optical receiver are each assigned an individua linear drive unit, which is designed either as an electric motor with a gear unit or as an electrodynamic linear direct drive or as a fluid-driven linear cylinder.

Furthermore, the linear drive system comprises a safety-oriented position-measuring system designed to determine a position of the optical source and the optical receiver relative to the machine frame or to the upper tool. In order to be able to ensure a safety-oriented determination of the position of the linear drive system relative to the machine frame or to the upper tool, the position-measuring system comprises a position sensor and a position checking system for the position sensor.

The position sensor provides the position resolution which is required for precisely determining the position of the linear drive. The function of the position checking system is to enable the safety-oriented linear drive controller to perform a plausibility check on the signals from the position sensor.

For example, the position sensor can be provided to provide a position resolution of 0.1 mm and the position checking system can either comprise a plurality of magnetic sensors arranged along a linear movement path of the linear drive system or can comprise a time measuring device. The task of the safety-oriented linear drive controller is then to check on the basis of the signals from the position checking system, whether the sensor signal from the position sensor is plausible.

If the position checking system is formed, for example, by magnetic sensors, the safety-oriented linear drive controller can determine, on the basis of the signals of the magnetic sensors, where the optical source and the optical receiver are approximately located and can compare this approximate position information with the sensor signal of the position sensor.

If the position checking system is formed by a time measuring device, the safety-oriented linear drive controller can determine an activation duration for the linear drive of the linear drive system and, from this activation duration and a known speed for the linear drive, can determine an approximate position for the optical source and the optical receiver, which can be compared with the sensor signal of the position sensor.

The position sensor can be designed as a relative measuring system, for example by detecting a rotation angle of a drive motor. Such a rotation angle detection can be carried out, for example, on the basis of pulses of a scanning sensor designed to scan the blades of a fan wheel of the drive motor.

The above combinations of position sensor and position checking system are also referred to as two-channel redundant measuring systems, since information from two different signal sources is compared by the safety-oriented position-measuring system.

It is particularly preferred that the position checking system is also designed as a position sensor. In particular, two identically designed position sensors can be used for this purpose, the sensor signals of which are provided to the safety-oriented linear drive controller.

Alternatively, technically completely different position sensors can be used, whereby a diverse redundancy is realized. At least one of the position sensors can be designed to determine position information directly, as is the case, for example, with an optical or magnetic sensor that scans a scale extending along the axis of movement. Alternatively, one or both position sensors can be designed for indirect position measurement, in which, for example, recurring events are determined during the movement. By way of example, it is envisaged that the position sensors are used to determine the revolutions of a drive shaft of an electric motor or of a threaded spindle, in order to be able to deduce the adjustment distance of the linear drive system from the number of revolutions, with knowledge of the properties of a gear mechanism downstream of the electric motor. Alternatively, the position can also be determined by sensing the teeth of a toothed belt drive.

Alternatively, the position sensor can be realized as an absolute measuring system, for example by scanning a glass scale provided with a unique Gray code. In this case, the position checking system can be designed in such a way that the position checking system checks each newly incoming sensor signal from the distance sensor to see if it lies exactly in a predetermined series of sensor signals that arrived earlier, thus making it possible to rule out the possibility of a measurement error in the absolute measurement system. Such a measuring system is referred to as single-channel because there is only a single signal source, and the safety-oriented properties are ensured by an additional signal evaluation.

In the safety-oriented design of the safety-oriented linear drive controller, the incoming sensor signals from the position sensor system are processed redundantly. To this end, for example, the safety-oriented linear drive controller can be comprised of two processors that operate independently of each other and, in particular, are designed and programmed differently in technological terms, each of which processes one of the sensor signals from the position sensor system. Furthermore, it is provided that after the processing of the sensor signals, a comparison of the resulting position information is carried out between the two processors, whereby a determined position value is assumed to be correct if both position information items are within a predetermined tolerance interval. In this case, the safety-oriented linear drive controller can use the determined position signal to trigger further steps of the bending machine. For example, the safety-oriented linear drive controller can provide a release signal to a machine controller of the bending machine, which machine controller may be a stored program control, so that the machine controller can initiate a movement of the upper tool when a corresponding operating switch, such as a foot switch, is subsequently actuated.

Alternatively, redundant signal processing in the safety-oriented linear drive controller can also be realized by the signals of the position measuring system being supplied to two independent calculation algorithms in a single processor in order to determine two items of position information which are then compared with each other, one determined position value being assumed to be correct if both items of position information lie within a predetermined tolerance interval.

Advantageous further developments of the invention are the subject of the subclaims.

It is advantageous if the safety-oriented linear drive controller comprises a communication interface to receive control information from a machine controller of the bending machine, which machine controller may be a stored program control, and to output safety information to the machine controller and/or to the light barrier controller and/or to a safety controller. In this context, it is assumed that the protective device is designed as a largely autonomously operating system that is intended for integration into a bending machine comprising a machine controller that is not of a safety-oriented design and a safety controller that is of a safety-oriented design. In this case, the communication interface of the safety-oriented linear drive controller is used, on the one hand, for communication with the machine controller, for example, to receive control information such as a tool dimension, in particular a tool height, from the machine controller.

On the other hand, the communication interface serves to output safety information that can be made available to the machine controller and/or to the light barrier controller and/or to the safety controller. The safety information may, for example, be an enabling signal that is used to indicate that the protective device has assumed a protective position that is necessary for the intended forming process and therefore is ready for performing the forming process. Accordingly, the communication interface comprises a first communication area for communication with the machine controller, wherein this communication area may be configured as a bus interface, for example, and may also be configured for bidirectional communication, in particular bus communication, with the machine controller.

In addition, the communication interface can comprise a second communication area for communication with the light barrier controller and/or with a safety controller, via which second communication area, for example, the release signal can be provided.

The problem of the invention is also solved by means of a bending machine. The bending machine comprises a machine bed on which a machine table is formed, which comprises a workpiece support surface for placing a workpiece thereon, as well as an upper tool that is mounted on the machine bed so as to be linearly movable along a movement axis, to which a drive unit is assigned and which, together with the machine table, defines a size-variable operating gap, as well as a machine controller for providing drive energy to the drive unit, further comprising a safety controller for interrupting a drive movement of the drive unit, and further comprising a protective device for safeguarding the operating gap, which protective device has an optical source for providing an optical beam and an optical receiver arranged opposite the optical source for receiving at least some rays of the optical beam, and a safety-oriented light barrier controller for redundant processing of sensor signals provided from the optical receiver, wherein the protective device comprises a linear drive system which is attached to the machine bed or to the upper tool to provide a linear movement of the optical source and the optical receiver along the axis of movement, wherein the linear drive system comprises a linear drive and a safety-oriented position-measuring system with a position sensor and a position checking system for the position sensor and wherein the protective device comprises an safety-oriented linear drive controller for, in particular redundant, processing of sensor signals of the position sensor and the position checking system and for controlled activation of the drive, wherein the safety-oriented linear drive controller is electrically connected to the machine controller for receiving control signals.

The bending machine can be designed, for example, as a press brake or as a swivel bending machine and comprises a machine table as a part of the machine bed and which comprises a workpiece support surface. In the case of a press brake, it can be provided that the machine table with the workpiece support surface is formed by the lower tool, which is also referred to as a die and is usually fixedly secured to the machine bed. In a press brake, the size-variable operating gap is determined by the distance between a lower edge of the upper tool, which is mounted on the machine bed so that it can move linearly, and an upper edge of the lower tool, which is fixed to the machine bed. In a folding machine, the operating gap is determined by a hold-down device, which is mounted on the machine bed so that it can move linearly, and the workpiece support surface.

A linear movement of the upper tool or the hold-down device is effected by a drive unit, which may be, for example, a combination of a hydraulic pump and one or several hydraulic cylinders or an electric motor with a downstream gear unit. In any case, it is provided that the machine controller is designed to supply drive energy, in particular electrical drive energy, to the drive mechanism in order to produce the desired relative movement of the upper tool or hold-down device with respect to the lower tool or the workpiece support surface and thus to cause an increase or decrease of the extension or size of the operating gap. Typically, the machine controller does not fulfill the requirements of a safety-oriented system, i.e. does not comprise safety-oriented measures like redundant signal processing. Rather, the machine controller is designed to execute a specified work program for the bending machine and to bring about the necessary movements, in particular of the upper tool or hold-down device, for this purpose.

For safe operation of the bending machine, an additional safety-oriented safety controller is provided. The task of this safety controller is to switch off the drive energy supplied by the machine controller to the drive unit, for example by interrupting an electrical connection between the machine controller and the drive unit or a contactor connected to the machine controller and the drive unit, and to ensure that the bending machine comes to a standstill as quickly as possible, in particular with regard to the upper tool or the downholder.

The safety controller is connected to the protective device which is designed for optical monitoring of the operating gap and has already been described above, wherein the protective device provides the electric signal to the safety controller if the optical beam is interrupted and therefore the drive unit of the bending machine is to be stopped. In addition, the safety controller can be connected to an emergency stop switch, for example, which can be operated directly by the operator in a critical situation to bring about an emergency stop of the bending machine. The safety controller is designed in particular to shut down the drive system for the bending machine when a safety-oriented shutdown signal is received from the light barrier controller and/or when a safety-oriented release signal is not received from the light barrier controller.

In a further development of the bending machine, the safety-oriented linear drive controller is integrated into the light barrier controller. This means that the processor architecture typically used for the light barrier control, which may comprise two or more processors, can also be used for the functions of the safety-oriented linear drive controller without compromising independent and/or redundant signal processing.

In a further development of the bending machine, it is envisaged that the safety-oriented linear drive controller system comprises a communication interface to receive control information from the machine controller and to output safety information to the machine controller and/or to the light barrier controller and/or to the separately designed safety controller, as described above. It is preferably provided that the safety-oriented linear drive controller can work completely autonomously, apart from an electrical energy supply and communication with the machine controls of the safety control, i.e. it does not require any further information from other components such as the light barrier controller or the safety controller for its function, which is of particular interest when retrofitting the protective device to an existing bending machine.

Preferably, the linear drive system of the bending machine comprises individually assigned drives for the optical source and for the optical receiver. This facilitates the integration of the protective device on a bending machine compared to a joint adjustment of the optical source and the optical receiver, since each of the drives can be attached to a favorable position on the bending machine and no consideration has to be given to the mechanical coupling between the optical source and the optical receiver. For example, it is envisaged that only the drive for the optical receiver comprises a position-measuring system with a redundantly designed sensor arrangement, while the drive for the optical source is not equipped with a position-measuring system. In this case, it is provided that when the position of the optical receiver is adjusted, a corresponding adjustment of the position of the optical source is carried out, whereby it can be checked by evaluating the sensor signal of the optical receiver whether the optical source is correctly aligned with the optical receiver and, if necessary, a correction can be made for the drive of the optical source.

The invention is includes a method for operating a bending machine, which comprises the following steps: providing information about the height of a upper tool of a bending machine from a machine controller of the bending machine to a safety-oriented linear drive controller of an linear drive system associated with the bending machine, controlling a linear drive of the linear drive system by means of the safety-oriented linear drive controller in order to displace an optical beam, which optical beam is provided by an optical source, and to displace an optical receiver, which is arranged opposite the optical source, opposite the optical source, with a linear adjustment movement into a reference position, which reference position is arranged adjacent to a default position which is calculated from the tool height for a lower edge of the upper tool, carrying out a position determination during the linear adjustment movement of the optical source and the optical receiver with respect to the upper tool, the position determination being carried out by the safety-oriented linear drive controller, which carries out a, in particular redundant, processing of a position signal of a position sensor of the linear drive system and of a signal of a position checking system of the linear drive system.

In a first step, the machine controller provides the safety-oriented linear drive controller with information about the tool height. This tool height is the extent of the upper tool in the direction of a movement axis, with this movement axis representing the spatial direction in which an approach and removal movement can be conducted between the upper tool and the workpiece contact surface. It is generally assumed that the upper tool is attached to a carriage that is mounted on the machine bed so that it can move linearly and can be set in motion by the drive mechanism.

When the carriage is at its maximum distance from the workpiece support surface, the operating gap is at its maximum width, which is the difference between this maximum distance and the height of the upper tool. In order to be able to carry out the desired protection of the operating gap, it is necessary that the optical source and the optical receiver arranged opposite it are positioned below of a lower edge of the upper tool in the direction of a closing movement in such a way that, if the optical beam provided by the optical source is interrupted, the upper tool can be brought to a standstill without any risk of an operator being crushed. This distance between the lower edge of the upper tool and the optical beam is determined in particular by the requirements for a minimum residual gap to avoid crushing as well as the braking distance for the upper tool. The upper tool's braking distance depends, among other things, on the upper tool's traversing speed during the closing movement, the processing time of a light barrier controller for the signals of the optical receiver and the processing time of the safety controller for the arrival of the light barrier controller's switch-off signal and the inertia of the moving components.

After the information on the height of the upper tool is provided to the safety-oriented linear drive controller, a default position and a reference position are determined in the safety-oriented linear drive controller on the basis of the provided tool height. The default position is the position that the lower edge of the upper tool theoretically assumes in a given machine coordinate system of the bending machine according to the provided information on the tool height. The reference position is the position that the optical source and the optical receiver must assume relative to the upper tool in order to achieve an arrangement of the optical beam immediately adjacent to the lower edge of the upper tool and thus immediately adjacent to the default position.

Preferably, the reference position is a maximum of 1 mm below the default position and thus below the lower edge of the upper tool.

After determining the default position and the reference position, the safety-oriented linear drive controller system actuates the linear drive system drive in such a way that a linear relative movement of the optical source and the optical receiver is effected, in particular in the direction of the reference position.

In the process, a position determination for a linear drive system takes place in the safety-oriented safety-oriented linear drive controller. The linear drive system carries both the optical source and the optical receiver and thus the spatial position of the optical beam provided by the optical source relative to the lower edge of the upper tool is mechanically determined by the linear drive system. The position determination for the linear drive system is based on a combination of a sensor signal of a position sensor that is assigned to the linear drive and signals of a position checking system that is also assigned to the linear drive. The sensor signals of the position sensor and the signals of the position checking system are processed separately in the safety-oriented linear drive controller in order to determine two position values which are based on different measurements or even on different measurement principles. The two position values are then compared with each other and a position value is output for the case where the two items of position information lie within a predetermined tolerance interval, this position value being used, for example, for a position control of the linear drive system.

It is preferably provided that during the relative movement of the linear drive system, carrying the optical source and the optical receiver, with respect to the upper tool, new position values are continuously determined in order to ensure a controlled positioning of the linear drive system for the entire linear position movement of the optical source and the optical receiver.

As soon as the linear drive system has positioned the optical source and the optical receiver relative to the upper tool such that the optical beam is in the reference position, the first phase of the method for operating the bending machine is complete.

In a further development of the method, it is envisaged that the safety-oriented linear drive controller actuates the linear drive system in such a way that, before the optical source and the optical receiver are moved to the reference position, the optical source and the optical receiver are moved to a maximum distance from the default position and afterwards to the reference position. This intermediate step is intended to ensure that incorrect information regarding the height of the upper tool does not impair the protective effect of the protective device. In this intermediate step, the optical beam passes over a considerable part of the operating gap in order to be able to detect any areas of the upper tool that may be below the default position. If the optical path between the optical source and the optical receiver is interrupted during the adjustment movement, the bending machine is shut down.

In a further development of the method, it is envisaged that the safety-oriented linear drive controller controls the linear drive system in such a way that the optical source and the optical receiver, starting from the reference position, are displaced in the direction of a distance between the reference position and the default position of the upper tool. In this step, the optical source and the optical receiver, and thus also the optical beam, are moved in the opposite direction to the closing direction of the upper tool. As a rule, this causes the optical beam to approach the lower edge of the upper tool.

The method is advantageous in that the safety-oriented linear drive controller outputs an error signal if, during the positioning of the optical source and the optical receiver in the direction of the distance between the reference position and the default position, a predetermined maximum distance from the reference position is reached without interruption of the of the optical beam provided by the optical source. In addition, it is advantageous that the safety-oriented linear drive controller interrupts a movement of the linear drive system if, during the positioning of the optical source and the optical receiver in the direction of the distance between the reference position and the default position an interruption of the optical beams occurs, before reaching the maximum distance from the reference position. In this case, the safety-oriented linear drive controller moves the optical source and the optical receiver from the interruption position, after a reversal of direction of the drive, to a predetermined safety position.

Provided that the machine controller has provided correct information on the tool height of the upper tool and the steps subsequently taken by the safety-oriented linear drive controller system have also been carried out correctly, it is to be expected that the position of the optical beam from the reference position in the direction of the default position will result in an interruption of the optical path, since the optical beam will be blocked by the upper tool. If this blocking of the optical beam occurs before a predetermined maximum distance from the reference position is reached, it can be assumed that all previous steps have been conducted correctly and that the upper tool does in fact comprise the tool height specified by the machine control.

If, however, the optical path is not interrupted when the optical beam is displaced from the reference position in the direction of the default position, such that the optical beam reaches the specified maximum distance from the reference position without interruption, it must be assumed that either the information on the height of the upper tool is incorrect or that at least one error has occurred during the execution of the preceding steps. In either case, the safety-oriented linear drive controller outputs an error signal to the safety controller, thereby preventing the bending machine from being put into operation. Accordingly, no bending process is conducted in this case.

The preferred method for the procedure is for the safety controller to control the linear drive system in such a way that the source and receiver of the optical beam are arranged at a predetermined safety distance from the lower edge position. This safety distance is determined in particular from the braking distance for the upper tool and the safety regulations to be observed when operating the bending machine.

In a further development of the method, it is envisaged that the safety oriented controller will output an enable signal when the optical source and the optical receiver are arranged at the specified safety distance from the lower edge position and that an energy flow will be provided from the machine controller to a drive system associated with the upper tool in order to enable a converging movement between the upper tool and a workpiece support surface of the bending machine, wherein the light barrier controller outputs an interruption signal or switches off a release signal when the optical beam is interrupted, and wherein a safety controller connected to the safety-oriented controller causes the energy flow to be blocked when the interruption signal arrives.

### BRIEF DESCRIPTION OF THE FIGURES

An advantageous embodiment of the invention is shown in the drawing. Here shows:

FIG. 1 a front view of a bending machine, designed purely as an example as a folding machine, which is equipped with a machine controller, with a protective device and with an associated safety controller, and

FIG. 2 a schematic partially cut side view of the bending machine according to FIG. 1.

### DETAILED DESCRIPTION

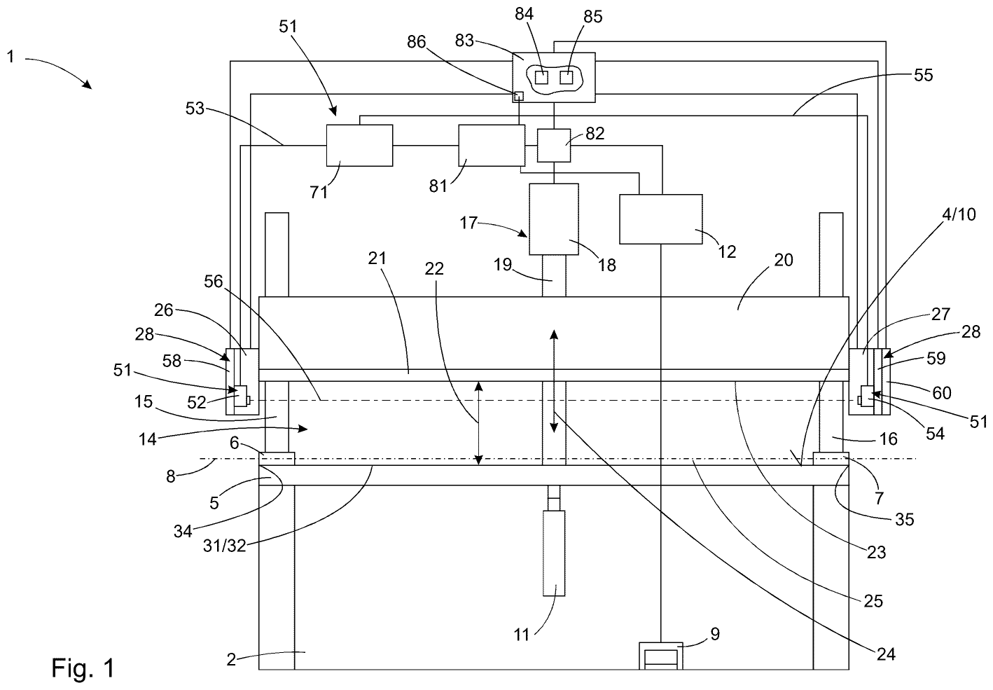

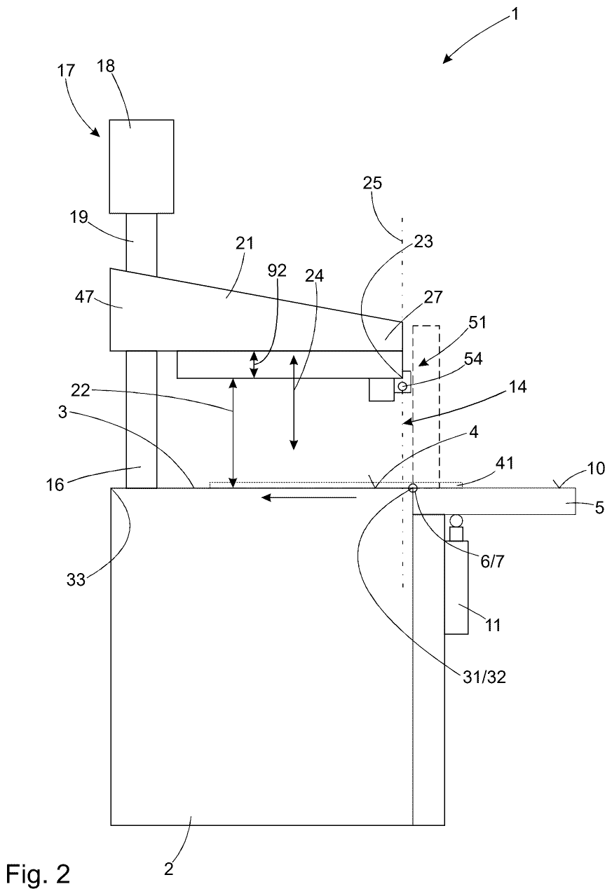

A folding machine 1, shown in FIGS. 1 and 2 as an example of a bending machine, comprises a machine bed 2 on which a workpiece table 3 is formed, which comprises an example of a flat workpiece support surface 4. As shown in FIGS. 1 and 2, the workpiece support surface 4, which is rectangular purely by way of example, is horizontally aligned and extends from a front edge 32 visible in FIG. 1 to a rear edge 33 visible in FIG. 2. Furthermore, the workpiece support surface 4 extends from a left side edge 34 to a right-side edge 35.

Furthermore, a bending cheek 5 is arranged on the machine bed 2 so as to be pivotally movable, which bending cheek 5 extends with a longest edge 31 along the front edge 32 of the workpiece support surface 4. At opposite end regions, the bending cheek 5 is attached to the machine bed 1 by means of a pivot joint 6, 7 respectively. The pivot joints 6, 7 define a common axis of rotation 8, which is aligned parallel to the workpiece support surface 4.

A working surface 10 of the bending cheek 5 can be swung out of the rest position by means of a swing drive 31 by a swinging movement of the bending cheek 5, as shown in FIG. 1, in which the working surface 10 is arranged parallel and flush with the workpiece support surface 4, into an functional position shown in FIG. 2 by a dashed line. In the functional position, the work surface 10 exemplarily assumes a right angle with respect to the workpiece support surface 4; other angular positions are also possible. The pivoting movement of the bending cheek 5 is initiated by a foot switch 9, which is connected to a machine controller 12 that can control or regulate the movement of the pivoting drive 31.

A movable upper tool 21, also referred to as a clamping cheek, is provided on the machine bed 2 for the purpose of securing a purely exemplary panel-shaped workpiece 41 to the workpiece table 3, as shown in dashed form in FIG. 2. The upper tool 21 is attached to a slide 20, which is guided on both sides by means of linear bearing on guide columns 15, 16, which in turn are fixed to the machine bed 2. A distance 22 between a lower edge 23 of the upper tool 21 and the workpiece table 3 can be adjusted by means of a spindle drive 17, which comprises an electric motor 18 and a drive spindle 19. A movement of the carriage 20 with the upper tool 21 attached to it between a first operating position, as shown in FIG. 1, with a maximum distance 22 from the workpiece support surface 4 and a second operating position with a minimum distance from the workpiece support surface 4 can thus be conducted along a movement axis 24, drawn as a double arrow. In this case, the lower edge 23 of the upper tool 21 moves between the first operating position and the second operating position in a movement plane 25, which is drawn in the FIG. 2 as a dashed line, which movement plane 25 is aligned transversely to the workpiece support surface 4 and which includes the lower edge 23.

A protective device 51, which also may be called an optical safety device, is assigned to the upper tool 21 to secure the operating gap 15, which protective device 51 may in particular be fixed to the carriage 20. The protective device 51 comprises an optical source 52 and an optical receiver 54. An optical beam 56, which is shown in dashed lines and can also be referred to as a beam of rays or an optical beam is provided by the optical source 52 and is directed to the optical receiver 54. Furthermore, the protective device 51 comprises a light barrier controller 71.

The optical source 52 can, for example, be designed as a discrete laser diode and is preferably configured in such a way that the respective optical beam 56 is emitted in the form of a parallel beam with an almost punctiform cross-section. By way of example, the optical receiver 54 is aligned in such a way that the optical beam 56 strikes an area of the optical receiver 54 that comprises a maximum optical sensitivity. The optical source 51 and the optical receiver 52 are electrically connected to the light barrier controller 71 via signal lines 53, 55. The light barrier controller 71 is designed to be fail-safe and comprises two processors, not described in more detail, by means of which incoming sensor signals from the optical receiver 52 can be redundantly processed. If the sensor signals from the optical receiver 52 indicate that the optical beam 56 has been interrupted or that there is a discrepancy between the processing results of the two processors of the light barrier controller 71, the light barrier controller 71 is designed to either output an interruption signal or to switch off an enable signal. This causes the safety controller 81, which is described in more detail below and is electrically connected to the light barrier controller 71, to be triggered.

The optical source 52 is attached to a first adjustment assembly 26, which can displace the optical source 52 relative to the upper tool 21, wherein the optical source 52 can perform a linear relative movement along the axis of movement 24 relative to the upper tool 21. The first adjustment assembly 26 is assigned a first position sensor 58 that is designed to detect a position of the optical source 52 relative to the upper tool 21.

The optical receiver 54 is attached to a second adjustment assembly 27, which can displace the optical receiver 54 relative to the upper tool 21, so that the optical receiver 54 can perform a linear relative movement along the axis of movement 24 relative to the upper tool 21. The second adjustment assembly 27 is assigned a second position sensor 59, which is designed to detect a position of the optical receiver 54 relative to the upper tool 21.

It is envisaged, for example, that the linear movements of the adjustment assemblies 26, 27 relative to the upper tool 21 are coordinated by a safety-oriented linear drive controller 83 in such a way that the optical source 52 and the optical receiver 50 are always located opposite one another. For this purpose, the safety-oriented linear drive controller 83 is connected via non-labeled electrical lines to the first adjustment assembly 26, to the second adjustment assembly 27, and to the first position sensor 58 and the second position sensor 59.

As an example, it can be provided that the first adjustment assembly 26 always follows the second adjustment assembly 27 in such a way that the optical receiver 54 is exposed to maximum irradiation from the optical source 52.

The safety-oriented linear drive controller 83 is designed to evaluate position signals from the first position sensor 58 and from position signals of the second position sensor 59, and to control the first adjustment assembly 26 and the second adjustment assembly 27.

Since the two position sensors 58 and 59 are each assigned to one of the two adjustment assemblies 26, 27, which can each be operated independently of one another, there is no redundant sensor signal for the respective position of the adjustment assemblies 26, 27. However, in order to be able to fulfill the requirements for a safety-oriented position detection at least for the adjustment assembly 27, which is assigned to the optical receiver 54, a further, third position sensor 60 is assigned to this adjustment assembly 27, which is also connected to the safety-oriented linear drive controller 83 via an unlabeled electrical line. In this case, the second position sensor 59 and the third position sensor 60 form a redundantly operating position measuring system 70 for the second adjustment assembly 27.

The first adjustment assembly 26, the second adjustment assembly 27 and the position sensors 58, 59, 60 form a linear drive system 28, which is electrically connected to the safety-oriented linear drive controller 83 and can be activated by the latter.

Furthermore, the safety-oriented linear drive controller 83 comprises a first processor 84 and a second processor 85 for the internal processing of the sensor signals of the position sensors 58, 59, 60, so that a redundant calculation of position values based on the sensor signals is possible. This is a necessary prerequisite for the safety-oriented design of the safety-oriented linear drive controller 83.

The safety controller 81 is electrically connected to the light barrier controller 71 and is designed to control a shut-off device 82. The shut-off device 82 can be, for example, an electrical contactor for the electric motor 18. This enables the safety controller 81 to shut down the drive motor 18 by interrupting the power supply even though electric energy is provided to the electric motor 18 by the machine controller 12. For example, the safety controller 81 is designed to check at regular intervals whether an enable signal is present from the light barrier controller 71 and is designed to activate the shutdown device if this enable signal is not present.

From the side view according to FIG. 2, only the optical receiver 54 can be seen, while the associated optical source 52 is not shown in FIG. 2.

The operation of bending machine 1 can be described as follows: first, an upper tool 21 is fixed to the slide 20 and a tool height 92 of the upper tool 21 is provided to the machine controller 12 via an input device. The machine controller 12 then transmits the tool height 92 to the safety-oriented linear drive controller 83, which calculates a default position based on the tool height 92. This default position represents the position of the lower edge 23 of the upper tool 21 relative to the first adjustment assembly 26 and the second adjustment assembly 27 under the provision that the tool height 92 has been correctly entered and the correct upper tool 21 has been mounted. Furthermore, the safety-oriented linear drive controller 83 calculates a reference position which is located adjacent, preferably less than 1 mm, in particular less than 0.5 mm, below the default position and which designates the location at which the optical beam with its beam of rays provided by the optical source 52 is not yet interrupted by the interfering contour of the upper tool 21.

Subsequently, an optional calibration process can be provided for the safety-oriented linear drive controller 83. Such a calibration is necessary after assembly or mechanical maintenance of the protective device 51. For this calibration process, the safety-oriented linear drive controller 83 actuates the two adjustment assemblies 26 and 27 in such a way that the optical beam 56, also known as a beam of rays, is shifted into the reference position in which it is arranged directly below the assumed position of lower edge 23 of the upper tool 21, which assumed position is also called the default position. If the optical beam is not interrupted as a result of this relative movement between the optical source and optical receiver and the upper tool 21, both adjustment assemblies 26 and 27 are activated in such a way that the optical beam 56 assumes a predetermined safety distance from the reference position. This safety position represents a distance of the optical source and optical receiver to the upper tool 21 which takes into account the speed of movement of the upper tool and the breaking distance which the upper tool 21 requires for a complete stop if the optical path between the optical source and the optical receiver is interrupted. As a further step in this calibration process and upon a respective action of a user, in particular by pressing a foot switch, the machine controller 12 then starts up the spindle drive 17, whereby a test rod of a defined diameter is placed by the user on the workpiece support surface 4. If the test rod interrupts the optical beam 56 in such a way that the subsequent shutdown of the spindle drive 17, due to the interaction of the light barrier controller 71, the safety controller 81 and the shutdown device 82, causes the upper tool 21 to decelerate and stop in such a way that the upper tool 21 does not touch the test rod, the positions of the two adjustment assemblies 26, 27 can be stored in the safety-oriented linear drive controller 83. Otherwise, the calibration process has to be repeated or the height information for the upper tool 21 has to be corrected.

This completes the calibration process and normal operation for the bending machine 1 can be resumed.

After another change of the upper tool 21, the machine controller 12 transmits the tool height 92 of the new upper tool 21 to the safety-oriented linear drive controller 83, which calculates a new default position and a new reference position from this.

The light barrier controller 71 then controls the two linear drive systems 26 and 27 in such a way that the optical beam 56 is moved to the reference position, where it is located directly below the lower edge 23 of the upper tool 21. If the optical beam has not been interrupted by the movement of the optical source 52 and the optical receiver 54 into the reference position, the safety-oriented linear drive controller 83 performs and additional calibration step, in which the safety-oriented linear drive controller 83 carries out a next activation of the two adjustment assemblies 26 and 27, in which the optical beam 56 is displaced in the direction of the lower edge 23 of the upper tool 21. If the optical beam 56 is interrupted because the optical path between the optical source 52 and the optical receiver 54 is blocked by the upper tool 21 before the optical beam 56 reaches a predetermined maximum distance from the reference position, the safety-oriented linear drive controller 83 causes a reversal of movement for the two adjustment assemblies 26, 27 by, in order to move the optical source 52 and the optical receiver 54 from the position at which the interruption of the optical beam 56 occurred to the predetermined safety distance with respect to the default position. If, however, the optical beam 56 is not interrupted when it moves towards the lower edge 23 of the upper tool 21 until it reaches the maximum distance from the reference position, the safety-oriented linear drive controller 83 provides a corresponding signal at the communication interface 86 for the safety controller 81, since in this case it must be assumed that the tool height provided by the machine controller 12 is not correct and therefore a start-up of the bending machine 1 must be prevented.

If it has been determined that the optical beam 56 has been interrupted and if the optical source 52 and the optical receiver 54 have been moved to the specified safety distance from the lower edge 23 of the upper tool 21, the safety-oriented linear drive controller 83 can provide an enable signal to the safety controller 81, so that subsequently, when the foot switch 9 is actuated, an approach movement of the upper tool 21 to the workpiece support surface 4 can be conducted for fixing the workpiece 41.

If the optical beam 56 is interrupted during the approach movement of the upper tool 21 to the workpiece support surface 4, the light barrier controller 71 at the communication interface 86 provides a corresponding signal for the safety controller 81, which in turn triggers the distance device 82 to cause the slide 20, with the upper tool 21 attached to it, to brake as quickly as possible.

In addition it can be provided that if the distance between the lower edge 23 of the upper tool 21 and the workpiece support surface 4 falls below a predetermined minimum, which ensures that a user cannot reach into the remaining operating gap, the sensor signal of the optical receiver 56 in the light barrier controller 71 is suppressed.

1. A protective device for safeguarding an operating gap of a bending machine, comprising:
an optical source to provide an optical beam along the operating gap,
an optical receiver arranged opposite the optical source to receive the optical beam,
a safety-oriented light barrier controller that performs redundant processing of sensor signals provided from the optical receiver, and
a linear drive system for attachment to the bending machine and for providing linear movements for the optical source and the optical receiver relative to an upper tool of the bending machine, the linear drive comprising a linear drive and a safety-oriented position measuring system with a position sensor and a position checking system,
wherein a safety-oriented linear drive controller is connected to the linear drive system and processes sensor signals from the position sensor and signals from the position checking system and provides a closed loop control for the linear drive.

2. The protective device according to claim 1, wherein the safety-oriented linear drive controller comprises a communication interface to receive control information from a machine controller of the bending machine and to output safety information to the machine controller and/or to output safety information to the light barrier controller and/or to output safety information to a safety controller.

3. A bending machine with a machine bed comprising:
a machine table, which defines a workpiece support surface for receiving a workpiece, and
with an upper tool mounted linearly movable along a movement axis on the machine bed by means of a drive unit,
wherein the upper tool defines a size-variable operating gap with the workpiece support surface of the machine table, with a machine controller for providing drive energy to the drive unit, with a safety controller for interrupting a drive movement of the drive unit, and with a protective device for safeguarding the operating gap, which protective device has an optical source for providing an optical beam and an optical receiver, arranged opposite the optical source, for receiving the optical beam and a safety-oriented light barrier controller for redundant processing of sensor signals from the optical receiver,
wherein the protective device comprises a linear drive which is attached to the machine bed or to the upper tool and which is designed to provide a linear movement of the optical source and the optical receiver along the axis of movement, the linear drive system comprising a linear drive and a safety-oriented position measuring system with a position sensor and a position checking system, wherein the protective device further comprises an safety-oriented linear drive controller for processing of sensor signals of the position sensor and of signals of the position checking system and for controlled activation of the drive, wherein the safety-oriented linear drive controller being electrically connected to the machine controller for receiving control signals.

4. The bending machine according to claim 3, wherein the safety-oriented linear drive controller is integrated into the light barrier controller.

5. The bending machine according to claim 3, wherein the safety-oriented linear drive controller comprises a communication interface to receive control information from the machine controller and to output safety information to the light barrier controller and/or to the safety controller.

6. The bending machine according to claim 3, wherein the linear drive comprises a linear drive for the optical source and a linear drive for the optical receiver.

7. A method for operating a bending machine, comprising the steps of:
providing information about a tool height of an upper tool of a bending machine from a machine controller of the bending machine to a safety-oriented linear drive controller of an linear drive system associated with the bending machine,
controlling a linear drive of the linear drive system with the safety-oriented linear drive controller in order to displace an optical beam, which optical beam is provided by an optical source, and to displace an optical receiver which is arranged opposite the optical source with a linear adjustment movement into a reference position, which reference position is arranged adjacent to a default position,
wherein the default position is calculated from the tool height for a lower edge of the upper tool, carrying out a position determination during the linear adjustment movement of the optical source and the optical receiver relative to the upper tool, the position determination being carried out by the safety-oriented linear drive controller which processes a position signal of a position sensor of the linear drive system and a control signal of a position checking system of the linear drive system.

8. The method according to claim 7, wherein the safety-oriented linear drive controller controls the linear drive system such that the optical source and the optical receiver are moved in a first step to a maximum distance from the default position and in a second step to the reference position.

9. The method according to claim 7, wherein the safety-oriented linear drive controller actuates the linear drive system starting from the reference position in such a way that the optical source and the optical receiver approach the upper tool.

10. The method according to claim 9, wherein the safety-oriented linear drive controller outputs an error signal if, during the positioning of the optical source and the optical receiver in the direction of upper tool without an interruption of the optical beam, wherein the safety-oriented linear drive controller interrupts a movement of the linear drive system if, during the positioning of the optical source) and the optical receiver in the direction of the distance between the reference position and the default position, before the preset maximum distance from the reference position is reached, an interruption of the optical beam provided by the optical source occurs.

11. The method according to claim 7, wherein the safety-oriented linear drive controller actuates the linear drive system in such a way that the optical source and the optical receiver are arranged at a predetermined safety distance below the upper tool.

12. The method according to claim 11, wherein the safety-oriented linear drive controller outputs an enable signal to the machine controller when the optical source and the optical receiver are arranged at the predetermined safety distance below the upper tool and wherein an energy flow form machine controller to a drive system associated with the upper tool is provided to provide an approach movement between the upper tool and a workpiece support surface of the bending machine, wherein the light barrier controller outputs an interruption signal when the optical beam is interrupted, and a safety controller connected to the light barrier controller causes the energy flow to the drive system to be blocked when the interruption signal arrives.
